(19) United States
(12) Patent Application Publication
(10) Pub. No.: US 2018/0322739 A1
(43) Pub. Date: Nov. 8, 2018

(54) SYSTEM AND METHOD FOR ASSISTANCE IN ELECTRONIC FUNDING OF WAGERING

(71) Applicant: Joze Pececnik, Kamnik (SI)

(72) Inventor: Joze Pececnik, Kamnik (SI)

(21) Appl. No.: 15/584,529

(22) Filed: May 2, 2017

(51) Int. Cl. G07F 17/32

(52) U.S. Cl. CPC G07F 17/3248; G07F 17/3246; G07F 17/3225; G07F 17/3211; G07F 17/3206; G07F 17/3241

(57) ABSTRACT

An electronic eWallet device configured to be embedded into an electronic gaming machine. The electronic eWallet device includes a case housing enclosing a first chip board configured for engagement with a ticket-in-ticket-out system in the electronic gaming machine, a second chip board configured for engagement with a currency validation system including a scanner in the electronic gaming machine and in-out communication ports for both the first chip board and the second chip board, and an eWallet antenna for communication with a personal external eWallet communicator.

### BACKGROUND OF THE ART

### 1. Field of the Invention

The present invention relates to the field of electronic casino gaming and to the use of eWallets in electronic gaming machines.

### 2. Background of the Art

Currently the primary method of transferring funds into a gaming device is through cash, or cash equivalent, e.g., “cash value tickets”, or ticket-in/ticket-out (TITO) tickets. Similarly, funds are transferred into an amusement device through cash, “cash value cards”, game tokens or coupons. The funds are usually converted into gaming or amusement credits through a cash acceptance device, e.g. bill acceptor or card reader, associated with the gaming device. The gaming or amusement credits are then exported onto cash value tickets or value on a card to be used in a gaming or amusement facility. At the discretion of the patron, the gaming or amusement credits can be redeemed and converted back into cash. A ticketing system or a value card system is used to read the tickets, print tickets, or write onto the value card the amount to be cashed out at an external kiosk or cashier station.

A patron usually accesses funds in his financial account via an Asynchronous Transfer Mode (ATM) machine or cash machine. While playing a game, if a patron runs out of cash and needs to access the funds in his bank account, he must stop the play at the gaming or amusement device, find an ATM machine, extract cash, convert the cash into cash equivalent (if necessary) and then return to the gaming or amusement device, and if it is not already occupied, insert the cash or the cash equivalent into the gaming or amusement device to continue play. Many players find this interruption in the gaming process not desirable, primarily because they don't want to loose their gaming device or position. Therefore there is a need for a more convenient way for the patrons to access their funds while playing in a gaming or amusement device without having to leave their device or position.

An ATM or a cash machine operates over an ATM network such as NYCE, PLUS, STAR, to transfer money from a cardholder's financial account to the ATM operator's account. The ATM operator or the property owner of the facility where the ATM is positioned and operated is responsible for loading the cash supply in the ATM, for the security of the cash, and for the maintenance of the ATM machine. Normally an ATM is connected to an ATM network, which is then connected to the customers' financial account. Financial institutions and banks have signed contracts with the ATM network to transfer money out of the customer's financial or bank account to the ATM network, and the ATM network pays the operator of the ATM.

A gaming device that accepts cash or cash equivalent funds from a patron, holds the funds in the form of “game credits” while the patron plays at the gaming or amusement device and enables the patron to retrieve his funds at any time. Therefore, gaming and amusement devices do not require the patron to input a wagerable or playable amount of money in the gaming or amusement device each time the player wishes to play a device. When the patron wins, the gaming or amusement devices do not require the patron to immediately take the winnings, if the patron desires to continue play. Furthermore, gaming or amusement devices provide a mechanism by which the patron can input and maintain a pool of money (i.e., credits) or for amusement credits of non-cash value in the gaming or amusement device to play many games of the gaming or amusement device. The gaming or amusement device can also accumulate and store the patron's winnings When the patron wishes to stop playing, the gaming or amusement devices provide a mechanism by which the patron can retrieve the money or non-cash value credits that remain in the pool. Accordingly, there is a need for an efficient fund transfer process to a gaming or amusement device that does not include the inefficient conversion of funds from bank accounts to cash to credit. There is also a need for a fund transfer process to a gaming or amusement device that does not require a large amount of cash in float in the gaming or amusement devices throughout the gaming or amusement facility. There is also a need for a less costly way for providing funds for gaming/amusement purposes.

Problems facing the current electronic funds transfer systems include security and fund transfer confirmation. Many regulatory agencies do not approve electronic funds transfer systems that do not confirm the fund transfer, i.e., there is no lasting evidence that a fund transfer has occurred. Therefore the electronic fund transfer system needs to provide such evidence, so that electronic funds transfers can occur in a more secure fashion. Accordingly, there is a need to make a secure electronic funds transfer system. A further need exists to provide evidence of the electronic transaction. A still further need exists to provide a wireless electronic fund transfer system designed to place the funds in the patron's hands rather than directly in the credit meter of the gaming device.

Further, in current gaming systems, because the transfer of money to game play is seamless, the gaming or amusement device is required to have the ability to send and receive authorization information, realize an amount of money that has been transferred, convert the money amount into a game or amusement credit amount, add or subtract an amount of credits that the player thereafter wins or loses and issue an appropriate cash out when the player desires. Accordingly, the game device's processor handles the normal game accounting in combination with the electronic funds transfer accounting.

Card and/or ticket systems are also used in connection with gaming or amusement machines, in cases where the gaming or amusement machines issue and accept cards and/or tickets in lieu of money. Such systems provide a workable cashless system on a local or property level. The casino operator redeems an amount of money from the card system for the assigned card and/or from the value imprinted on the ticket through visual inspection or via a ticket validation system. Card and/or ticketing systems are advantageous because they reduce the amount of cash transactions and the need for the patron to transport and hold large amounts of cash or coins. Consequently, ticketing systems have become common in most gaming and amusement jurisdictions. Various manufacturers produce these types of ticketing systems. These systems require each machine to have a card reader and/or ticket printer.

The role of the card reader device and/or ticketing machines has recently been expanded to enable patrons to redeem the card value and/or ticket at a gaming or amusement device. As before, the card and/or ticketing system issues cash out card credit to the card system and/or ticket in response to a patron's cash out request. In the expanded role, the cash out card and/or ticket includes information that enables the patron to present the card and/or ticket to a cashier or redemption machine, as before, or to re-insert the card and/or ticket into a gaming or amusement device configured to accept card and/or ticket transactions.

In this expanded role, the card and/or ticket accepting gaming or amusement devices must now contain a card and/or ticket reader as well as the card system communication and/or ticket printer. In the expanded system, the cash out card communicates with a local card system which tracks date and time of cash out credits for the identification card and the ticket typically contains a barcode, a written ticket amount, the time and date of printing, a numerical representation of the barcode and other identification and validation information specific to the property. To redeem the card and/or ticket for its cash or non-cash value, the patron either presents the card and/or ticket to the operator, who validates the card and/or ticket and pays the patron an amount of money or prizes, or the patron inserts the card and/or ticket into a card and/or ticket-ready gaming or amusement device, whereby the gaming or amusement device provides the patron with a number of credits equal to the amount represented by or encoded in the card system or on the ticket.

The controllers of the card and/or ticket-ready gaming devices are adapted to coordinate with the card and/or ticket validation system. For example, when a payout is issued the card and/or ticket is inserted into a card and/or ticket reader equipped in a gaming or amusement device, the ticket reader forwards information, which can be stored on a barcode in the instance of tickets, to the game's or amusement's controller. The game or amusement controller recognizes this information as card and/or ticket information and forwards the card and/or ticket information to a card and/or ticket validation system outside the gaming or amusement device. The card and/or ticket validation system analyzes the card and/or ticket information, and if the card and/or ticket is valid, the card and/or ticket validation system provides the game or amusement controller with an authorization to credit the gaming machine with the amount represented by the credits in the card system or represented by encoded value on the ticket.

Alternatively, if the card and/or ticket validation system detects that the card and/or ticket is not valid, the card and/or ticket validation system instructs the game or amusement controller to reject the card and/or ticket. The card and/or ticket validation system may also log the failed attempt in a statistical database that will record the Information for future reference.

Card and/or ticketing benefits each patron, not just those wishing to access funds from or near the gaming and/or amusement device. Gaming and amusement establishments have also become familiar with the card and ticketing systems and their proven performance. Card and ticketing systems are proliferating within the gaming and amusement industry.

Accordingly, a need exists for an electronic funds transfer system that eliminates the inefficiency of the intermediary step of having to use an ATM cash machine to transfer money from a patron's bank account to a gaming device. Furthermore, a need exists for an electronic funds transfer system that utilizes the card and/or ticketing system's hardware and software as much as possible to avoid duplication of such hardware and software in accounting for the transfer of the electronic funds.

### SUMMARY OF THE INVENTION

An electronic eWallet device configured to be embedded into an electronic gaming machine. The electronic eWallet device includes a case housing enclosing a first chip board configured for engagement with a ticket-in-ticket-out system in the electronic gaming machine, a second chip board configured for engagement with a currency validation system including a scanner in the electronic gaming machine and in-out communication ports for both the first chip board and the second chip board, and an eWallet antenna for communication with a personal external eWallet communicator.

### BRIEF DESCRIPTION OF THE FIGURES

FIG. 1 is a schematic of an electronic eWallet device that may be added to, retrofit to or embedded in an electronic gaming machine.

FIG. 2 is a perspective view of an electronic gaming machine having the electronic eWallet device of FIG. 1 attached and connected to the electronic gaming machine.

### DETAILED DESCRIPTION OF THE INVENTION

An electronic eWallet device configured to be embedded into an electronic gaming machine. The electronic eWallet device includes a case housing enclosing a first chip board configured for engagement with a ticket-in-ticket-out system in the electronic gaming machine, a second chip board configured for engagement with a currency validation system including a scanner in the electronic gaming machine and in-out communication ports for both the first chip board and the second chip board, and an eWallet antenna for communication with a personal external eWallet communicator.

Certain systems are known in the art for electronic money transfer and payment systems which would be desirable for use in gaming equipment. Such systems are generally disclosed and enabled in U.S. Pat. Nos. 6,726,100; 6,032,858 and 6,321,980; and Published US Application Document Nos. 20140244161; 20140214654; 20060059038; and 20030034389. These documents are incorporated herein by reference in their entirety.

Before we go any further, understand that the term digital wallet is a blanket descriptor for a range of technologies that let you perform many tasks. In general, though, a digital wallet (also sometimes called an e-wallet) is a transformation in the way you pay for things.

Many digital wallet services work through apps on your smartphone. At the supermarket, for instance, you might simply tap your phone to a compatible check-out register to pay instantly. For others, all you need to use them is something you know, such as your mobile phone number and a PIN (personal identification number).

No matter what form it takes, a digital wallet is based on encryption software that substitutes for your old, analog wallet during monetary transactions. Players can benefit from the protection and convenience. Merchants benefit because they're more protected against fraud and they sell more products, faster.

A smartphone digital wallet will help you pay for stuff, but it will also store your concert tickets, bus and subway passes and gift cards. Retailers will reward your loyalty by offering instant freebies, discounts and coupons. Your digital wallet might even unlock the doors to your house.

A digital wallet could alter the way players organize finances and wagering activities and strategies. The types of digital wallets fall into two broad categories: client-side and server-side. Within both categories are wallets that function only with specific vendors (either online or offline) and others that will work with just about any merchant.

Client-side wallets generally refer to those maintained by the player, the end user. They download and install a program and then enter all pertinent payment and shipping information, all of which is stored on a own personal computer. Then, when a player decides to engage out at a compatible Web site or gaming environment, the wallet's software completes most of the basic information so the player doesn't have to.

A mobile digital wallet—that is, one on a smartphone—could transform the way players access credit no matter where they are. More than half of Americans now own smartphones, and experts say that number will only continue to rise. More and more of those phones are equipped with an NFC (near-field communication) chip, which is a vital component to the mobile digital wallet infrastructure, it was estimated that around half of smartphones could have NFC by 2015, New individuals who have never heard of NFC technology, may see it everywhere very soon.

When it comes to unveiling digital wallets to consumers, two hot-button words always appear: security and privacy. It's easy for people to imagine all of the ways criminals could abuse digital wallets. Those digitally masked terminals could hack into your account, spend away players' life savings and run up your credit card balances. Or maybe they'd steal the players' identity.

Concerns are heightened when considering the complexity of a digital-wallet transaction, especially compared to the simplicity of cash or straight credit. In the case of a smartphone, data passes through not only the smartphone's hardware and operating system but then also through a specific payment app, and finally, the source of the payment, such as a bank or PayPal account.

Major companies are falling all over themselves to get digital wallet business, Household names such as Google, Visa, MasterCard, Verizon, Apple, AT&T, PayPal and Square are vying for customers' attention. Access through casinos and electronic wagering machines would be a greatly enhanced market.

All of these organizations are jockeying for the upper hand, in part by creating alliances with other corporate giants. PayPal® started with Home Depot. Square teamed up with Starbucks. Google Wallet first found love with MasterCard. It's all part of the plan to slowly worm their way into customers' lives. They know that if they can convince customers to use their form of wallet first, they'll be unlikely to switch anytime soon.

Eventually, digital will complete its takeover and we'll all be left using virtual money. Whether that's a good thing remains to be seen. In the meantime, we all fumble with cash and checks, both of which are remnants of a pre-digital economy and are primitive (and sometimes aggravating) simply by the nature of their design. Digital, of course, will have its own set of frustrations, and until they are all confronted, we won't know how successful they will be in a gaming environment. A Google Wallet is inherently no different than any other money wallet. The basics behind all the wallets are the same. Each wallet is a bank account in some banking system. The entire eco system of wallet users, are simply a singular branch. If the name “PayPal”® is eliminated, it depicts very well how a digital money wallet works.

The key here is to understand the notion of a bank-branch access Oven to the company to run its mobile wallet (or in some cases, a complete CBS—Core Banking Solution), but one that would integrate with the originating bank's solution). It's a simple Concept which a bank follows. It must be remembered that e-Wallets don't need to show the physical money (liquid cash), they just show numbers.

The input control should be a near field communication system responsive to manual activity within a responsive near field range of sensitivity. The wager may be a real value, or the event may be played for non-economic (non-wagering) entertainment value as a table top video game or arcade game. The player input may have a near field communication surface over, in or under the player input device surface. A lock-in and queuing system may be provided in order to manage multiple users. The method may have the input control comprises a near field communication system which responds to manual activity of the player within a responsive near field range of sensitivity.

The method may have a player inputting at least one wager at the player input terminal, wherein inputting at the player input panel comprises at least one input entered by at least one control selected from the group consisting of buttons, touchscreens, levers, voice recognition and eye movement recognition components. The method may have a player initiates a direction of movement over the near field communication system directs activity, including the ticket-in-ticket-out technology (scanning and printing), currency validation, and wallet transmission/communication.

There may be an external antenna coupled to the device via any suitable cable connector, such as BNC, F-type, FME, MC-Card, MCX, MMCX, QMA, SMB, SSMB, and the like.

NFC is a set of short-range wireless technologies, typically requiring a separation of 10 cm or less. NFC operates at 13.56 MHz on ISO/IEC 18000-3 air interface and at rates ranging from 106 kbit/s to 424 kbit/s. NFC always involves an initiator and a target; the initiator actively generates an RF field that can power a passive target. This enables NFC targets to take very simple form factors such as unpowered tags, stickers, key fobs, or cards. NFC peer-to-peer communication is possible, provided both devices are powered.

NFC tags contain data and are typically read-only, but may be writeable. They can be custom-encoded by their manufacturers or use NFC Forum specifications. The tags can securely store personal data such as debit and credit card information, loyalty program data, PINs and networking contacts, among other information. The NFC Forum defines four types of tags that provide different communication speeds and capabilities in terms of configurability, memory, security, data retention and write endurance. Tags currently offer between 96 and 4,096 bytes of memory.

As with proximity card technology, near-field communication uses magnetic induction between two loop antennas located within each other's near field, effectively forming an air-core transformer. It operates within the globally available and unlicensed radio frequency ISM band of 13.56 MHz. Most of the RF energy is concentrated in the allowed ±7 kHz bandwidth range, but the spectral mask for the main lobe is as wide as 1.8 MHz. Theoretical working distance with compact standard antennas: up to 20 cm (practical working distance of about 10 cm). Supported data rates: 106, 212 or 424 kbit/s (the bit rate 848 kbit/s is not compliant with the standard ISO/IEC 18092)

The two modes are:
Passive—The initiator device provides a carrier field and the target device answers by modulating the existing field. In this mode, the target device may draw its operating power from the initiator-provided electromagnetic field, thus making the target device a transponder.
Active—Both initiator and target device communicate by alternately generating their own fields. A device deactivates its RF field while it is waiting for data. In this mode, both devices typically have power supplies.

| Speed | Active Device | Passive device |
|---|---|---|
| 424 kbits/s | Man, 10% ASK | Man, 10% ASK |
| 212 kbits/s | Man, 10% ASK | Man, 10% ASK |
| 106 kbits/s | Modified Miller, 100% | Man, 10% ASK |
| | ASK | |

NFC employs two different coding to transfer data. If an active device transfers data at 106 kbit/s, a modified Miller coding with 100% modulation is used. In all other cases Manchester coding is used with a modulation ratio of 10%.

NFC devices are full-duplex—they are able to receive and transmit data at the same time. Thus, they can check for potential collisions if the received signal frequency does not match the transmitted signal's frequency.

Although the range of NFC is limited to a few centimeters, plain NFC does not ensure secure communications. NFC offers no protection against eavesdropping and can be vulnerable to data modifications. Applications may use higher-layer cryptographic protocols (e.g. SSL) to establish a secure channel.

The RF signal for the wireless data transfer can be picked up with antennas. The distance from which an attacker is able to eavesdrop the RF signal depends on multiple parameters, but is typically less than 10 meters. Also, eavesdropping is highly affected by the communication mode. A passive device that doesn't generate its own RF field is much harder to eavesdrop on than an active device. An attacker can typically eavesdrop within 10 m and 1 m for active devices and passive devices, respectively.

Because NFC devices usually include ISO/IEC 14443 protocols, relay attacks are feasible. For this attack the adversary forwards the request of the reader to the victim and relays its answer to the reader in real time, pretending to be the owner of the victim's smart card. This is similar to a man-in-the-middle attack. ^{[}One libnfc code example demonstrates a relay attack using two stock commercial NFC devices. This attack can be implemented using only two NFC-enabled mobile phones.

NFC Protocol Stack Overview

NFC standards cover communications protocols and data exchange formats, and are based on existing MID standards including ISO/IEC 14443 and FeliCa. The standards include ISO/IEC 18092 and those defined by the NFC Forum.

NFC is standardized in ECMA-340 and ISO/IEC 18092. These standards specify the modulation schemes, coding, transfer speeds and frame format of the RF interface of NFC devices, as well as initialization schemes and conditions required for data collision-control during initialization for both passive and active NFC modes. They also define the transport protocol, including protocol activation and data-exchange methods. The air interface for NFC is standardized in:
ISO/IEC 18092/ECMA-340—Near Field Communication Interface and Protocol-1 (NFCIP-1)
ISO/IEC 21481/ECMA-352—Near Field Communication Interface and Protocol-2 (NFCIP-2)

NFC incorporates a variety of existing standards including ISO/IEC 14443 Type A and Type B, and FeliCa. NFC-enabled phones work at a basic level with existing readers. In “card emulation mode” an NFC device should transmit, at a minimum, a unique ID number to a reader. In addition, NFC Forum defined a common data format called NFC Data Exchange Format (NDEF) that can store and transport items ranging from any MIME-typed object to ultra-short RTD-documents, ^{[44]}such as URLs. The NFC Forum added the Simple NDEF Exchange Protocol (SNEP) to the spec that allows sending and receiving messages between two NFC devices.

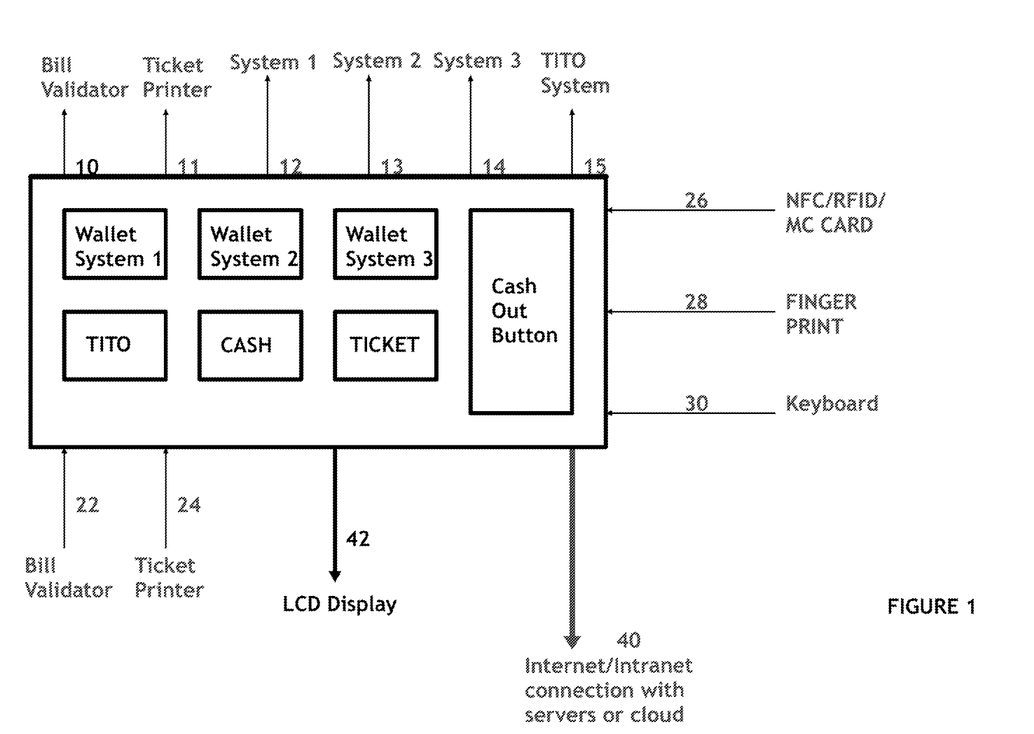

FIG. 1 shows a schematic of a value-in-value-out component 20 of the present invention. Included within the value-in-value-out component 20 of the present invention are shown such variety of subcomponents such as three separate wallet chips 1, 2 and 3, respectively associated with a TITO (ticket-in-ticket-out) functionality, cash (currency and/or coin) functionality, and a ticket or credit card functionality. The value-in-value-out component 204 may be in communication with an existing or embedded bill validator input 22, ticket printer input (scanner) 24 and LCD display 42. Also shown in the value-in-value-out component 20 is a physical (button/touchscreen) Cash out button. Also shown in the FIG. 1 are bill validator out communication path 10, ticket printer out path 11, and three optional or additional output paths 12, 13 and 14, as well as a TITO output path 15. In communication with or embedded in the value-in-value-out component may be a link into the component from a communication or sensing system such as a near field communicator (NFC), radio frequency ID (RFID) or MC Card 26, biometric sensor 28 or keyboard input 30. There should also be an internet/intranet connection with servers or the cloud 40 for external credit communication.

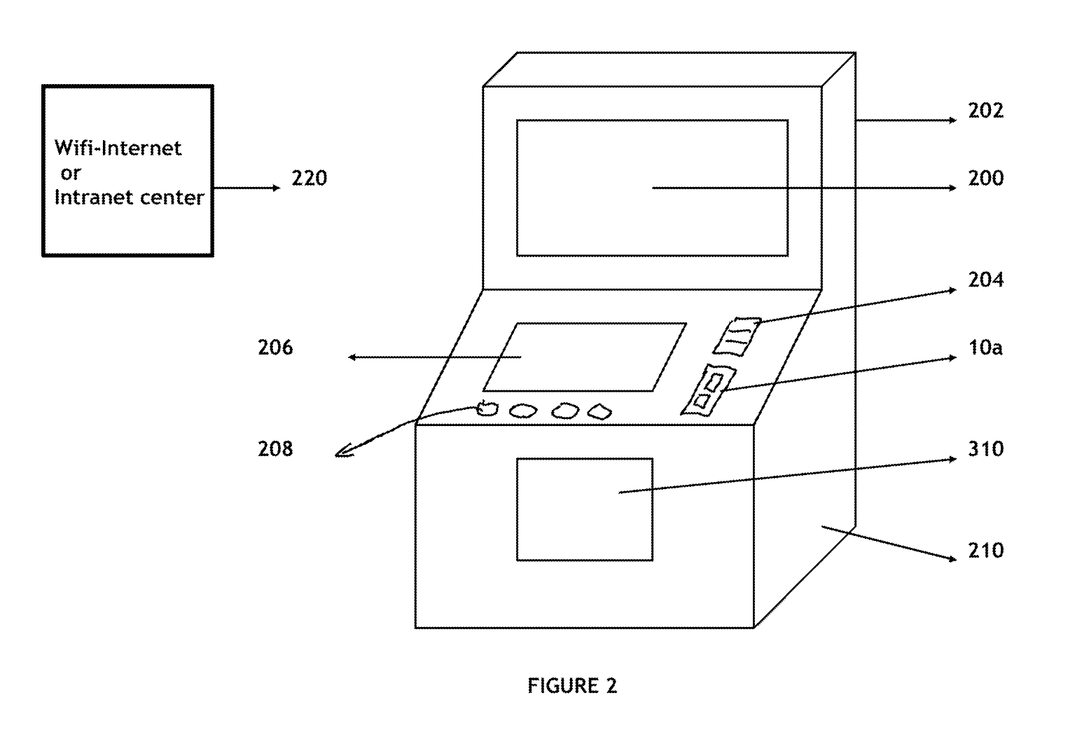

Looking at FIG. 2, the gaming machine 200 includes a top box 202, which sits on top of the main cabinet 210. The top box 202 houses a number of devices, which may be used to add features to a game being played on the gaming machine 200, including speakers 10a, a value-in-value-out component 204 of the present invention which may include ticket printer, currency acceptor, coin acceptor, and e-Wallet communicator which includes a printer that prints bar-coded tickets, a button array 208 for entering player tracking information, a display screen (which may have touchscreen functionality) 206 for displaying player tracking information and game content and accepting player input, in addition to the button array 206. The ticket printer associated with the value-in-value-out component 204 may be used to print tickets for a cashless ticketing system. Further, the top box 202 may house different or additional devices than shown in the FIG. 1. For example, the top box may contain a bonus wheel or a back-lit silk screened panel which may be used to add bonus features to the game being played on the gaming machine. As another example, the top box may contain a display for a progressive jackpot offered on the gaming machine. During a game, these devices are controlled and powered, in part, by circuitry (e.g. a master gaming controller) housed within the main cabinet 210 of the machine 200.

During certain game events, the gaming machine 200 may display visual and auditory effects that can be perceived by the player. These effects add to the excitement of a game, which makes a player more likely to continue playing. Auditory effects include various sounds that are projected by the speakers 10a. Visual effects include flashing lights, strobing lights or other patterns displayed from lights on the gaming machine 200 or from lights within a separate mechanical (or electronic) separately, individually wagerable gaming system. After the player has completed a game, the player may receive game tokens from a coin tray or the ticket from the printer in the value-in-value-out component 204 of the present invention, which may be used for further games or to redeem a prize. Further, the player may receive a ticket for food, merchandise, or games from the printer. A lower door entry 310 may access to components such as processors and memory (not shown).

This technology may be further described as an electronic eWallet device configured to be embedded into an electronic gaming machine, the electronic eWallet device including:

a case housing enclosing a first chip board configured for engagement with a ticket-in-ticket-out system in the electronic gaming machine, a second chip board configured for engagement with a currency validation system including a scanner in the electronic gaming machine and in-out communication ports for both the first chip board and the second chip board, and an eWallet antenna for communication with a personal external eWallet communicator. The electronic eWallet device may further include a physical cash out input control embedded in the case that is configured to communicate through a port in the case with a processor in the electronic gaming machine and communicate commands to a ticket-out printer in the electronic gaming machine to provide a ticket of removed credit.

A processor is present within the case and is configured to communicate to a video display screen on the electronic gaming machine. The electronic eWallet device of may further include an I/O port configured to communicate with a biometric security reader configured to provide authorization limitations on the electronic eWallet device.

The electronic eWallet device may have an input port configured to receive electronic communication from a a) near field communication card, b) radio frequency identification card or c) antenna card in the electronic gaming machine and/or a biometric security reader configured to provide authorization limitations on the electronic eWallet device.

An electronic gaming machine includes a housing, a processor, memory, player input controls and a value-in-value-out system comprising a ticket-in-ticket-out printer and scanner, and attached to the housing an electronic eWallet device including:

a case housing enclosing a first chip board configured for engagement with the ticket-in-ticket-out system in the electronic gaming machine, a second chip board configured for engagement with a currency validation system including a scanner in the electronic gaming machine and in-out communication ports for both the first chip board and the second chip board, and an eWallet antenna for communication with a personal external eWallet communicator

What is claimed:

1. An electronic eWallet device configured to be embedded into an electronic gaming machine, the electronic eWallet device comprising:
a case housing enclosing a first chip board configured for engagement with a ticket-in-ticket-out system in the electronic gaming machine, a second chip board configured for engagement with a currency validation system including a scanner in the electronic gaming machine and in-out communication ports for both the first chip board and the second chip board, and an eWallet antenna for communication with a personal external eWallet communicator.

2. The electronic eWallet device of claim 1 further comprising a physical cash out input control embedded in the case that is configured to communicate through a port in the case with a processor in the electronic gaming machine and communicate commands to a ticket-out printer in the electronic gaming machine to provide a ticket of removed credit.

3. The electronic eWallet device of claim 1 wherein a processor is present within the case and is configured to communicate to a video display screen on the electronic gaming machine.

4. The electronic eWallet device of claim 1 further comprising an I/O port configured to communicate with a biometric security reader configured to provide authorization limitations on the electronic eWallet device.

5. The electronic eWallet device of claim 2 further comprising an I/O port configured to communicate with a biometric security reader configured to provide authorization limitations on the electronic eWallet device.

6. The electronic eWallet device of claim 3 further comprising an I/O port configured to communicate with a biometric security reader configured to provide authorization limitations on the electronic eWallet device.

7. The electronic eWallet device of claim 1 having an input port configured to receive electronic communication from a a) near field communication card, b) radio frequency identification card or c) antenna card in the electronic gaming machine.

8. The electronic eWallet device of claim 1 further comprising a biometric security reader configured to provide authorization limitations on the electronic eWallet device.

9. The electronic eWallet device of claim 1 further comprising a) a near field communication card, b) a radio frequency identification card or c) an antenna card in the electronic gaming machine.

10. An electronic gaming machine comprising a housing, a processor, memory, player input controls and a value-in-value-out system comprising a ticket-in-ticket-out printer and scanner, and attached to the housing an electronic eWallet device comprising:
a case housing enclosing a first chip board configured for engagement with the ticket-in-ticket-out system in the electronic gaming machine, a second chip board configured for engagement with a currency validation system including a scanner in the electronic gaming machine and in-out communication ports for both the first chip board and the second chip board, and an eWallet antenna for communication with a personal external eWallet communicator.

11. The electronic gaming machine of claim 10 further comprising a physical cash out input control embedded in the case that is configured to communicate through a port in the case with a processor in the electronic gaming machine and communicate commands to a ticket-out printer in the electronic gaming machine to provide a ticket of removed credit.

12. The electronic gaming machine of claim 10 wherein a processor is present within the case and is configured to communicate to a video display screen on the electronic gaming machine.

13. The electronic gaming machine of claim 10 further comprising an I/O port configured to communicate with a biometric security reader configured to provide authorization limitations on the electronic eWallet device.

14. The electronic gaming machine of claim 11 further comprising an I/O port configured to communicate with a biometric security reader configured to provide authorization limitations on the electronic eWallet device.

15. The electronic gaming machine of claim 12 further comprising an I/O port configured to communicate with a biometric security reader configured to provide authorization limitations on the electronic eWallet device.

16. The electronic gaming machine of claim 1 having an input port configured to receive electronic communication from a a) near field communication card, b) radio frequency identification card or c) antenna card in the electronic gaming machine.

17. The electronic gaming machine of claim 10 further comprising a biometric security reader configured to provide authorization limitations on the electronic eWallet device.

18. The electronic gaming machine of claim 10 further comprising a) a near field communication card, b) a radio frequency identification card or c) an antenna card in the electronic gaming machine.
